(19) United States
(12) Patent Application Publication
(10) Pub. No.: US 2001/0010201 A1
(43) Pub. Date: Aug. 2, 2001

(54) Flag protector

(76) Inventor: Alfred C. Otterness, Spring Grove, MN (US)

Correspondence Address: M. Paul Hendrickson, 403 Main Street, P.O. Box 508, Holmen, WI, 54636-0508, US

(21) Appl. No.: 09/779,938

(22) Filed: Feb. 8, 2001

Related U.S. Application Data
(63) Continuation-in-part of application No. 09/492,684, filed on Jan. 27, 2000.

(51) Int. Cl. G09F 17/00

(52) U.S. Cl. 116/173; 116/174

(57) ABSTRACT

Unflurred flags are protected by equipping flag poles with a flag protector. The flag protector for protecting an unflurred flag includes a tubular chamber housing an internal cavity for the unflurred flag which chamber is vertically mounted along a staff of the flag pole. The tubular chamber includes a rope passageway communicating through the internal chamber for raising and lowering the flag with a rope along the staff. The tubular member is capped with a protective closure for protecting the unflurred flag stowed within the tubular chamber from the elements. A slotted deformable and flexible dome capping the tubular member which will deform upon pressure by an emerging flag drawn against the dome so as to provide a flag passageway and allow the flag to be pulled from and into the internal chamber after which the dome returns to its original dome configuration provides a particularly effective cap for the flag protector. The bottom of the chamber may also be fitted with a lock for locking and securing the flag within the flag confines of the internal chamber.

This application is a continuation in part of U.S. patent application Ser. No. 09/492684 filed Jan. 27, 2000 and entitled “Flag Protector”.

### FIELD OF THE INVENTION

The present invention relates to a stowing device and its use, and more particularly to a flag protector for stowing a flag upon a flag pole.

### BACKGROUND OF THE INVENTION

Throughout the years, numerous flag protecting devices have been proposed. These protective units are designed to provide storage for an unflurred flag and to allow the flag to be unfurled from its protective housing to a flagging position. Typical of the prior art relating to the protective flag storage units is disclosed in U.S. Pat. No. 3,920,001 to Murdock which discloses a flag pole having an upper tube and a lower tube and an endless cable driven between two pulleys. The cable suspended flag may be drawn within the upper tube with the cable.

In another patent issued to Nowalk, et al (U.S. Pat. No. 5,983,825) there is disclosed a flag protective device which includes a flexible sleeve adapted for engagement onto a tapered flag staff which may be lowered over the flag by a central control unit. Another patent in the U.S. Pat. No. 4,332,210 to Lambert discloses a flag pole system for automatically displaying and unfurling a flag involving a cylindrical housing with a sensing system which activates a motor to retract the flag into the housing. U.S. Pat. No. 5,550,000 to Fu discloses a flag pole system comprised of a tubular pole having an inner tube, a shaft and a spherical cap within which the flag may be wrapped onto the inner tube by a flag wrapping mechanism. German Patent No. 3737655 A1 discloses a cylindrical housing closed at a top end so as to protect a distress flag from the elements and an open bottom end from which the distress flag may be dropped upon activation.

Although the prior art has long sought a protective flag device, the proposed flag protectors are either excessively complicated, costly or too over-simplified to effectively serve as a flag protector.

### SUMMARY OF THE INVENTION

The present invention provides a unique flag stowing device for effectively protecting a stowed flag against the elements. The flag protector permits the flag to be lowered by pulling the flag into a protective chamber with a rope attached to the bottom and top eyelet of the flag. The rope may be connected to a handled winch and strung about a pulley near the top of the flag staff which by pulling or a turning of a crank handle, will lower the flag. Conversely, the flag may be raised to the desired height by pulling the rope in an opposite direction. The winch may be replaced simply with a free hanging continuous rope or even a remote control motor mounted on the flag pole which, when activated, can raise or lower the flag. The flag protector may be in the form of an attachment or directly incorporated into the flag pole design. The flag size generally prescribes the appropriate width and length of the storage tube for the flag. The storage tube is preferably weather sealed at the top and may be sealed at the bottom with a door or a lock to protect the flag from theft.

The flag protector is adapted to be used in conjunction with flag poles equipped with a flag, an upper pulley and a continuous rope extending along the flag pole and strung about the upper pulley so as to permit the flag to be raised to a flagging position or lowered to a non-flagging position. The flag protector includes a hollow tubular member equipped with an internal cavity or chamber sized to house the flag within the tubular member. The tubular member extends along the longitudinal axis of the flag pole for a distance sufficient so as to provide satisfactory room for housing the flag within the tubular member. The flag protector also includes a flag receiving closure along a top margin of a tubular member which closure is designed so as to allow passage of a flag into the internal chamber and for closure of the internal cavity or chamber after the flag has passed through the closure. The tubular member includes a rope passageway which provides an entry and exit for the rope from the tubular member so as to permit the rope and attached flag to be withdrawn from the internal cavity to a flagging position and, when desired to protect the flag, to be drawn within the internal cavity to a non-flagging position.

The closure closes the top of the tubular member so that the encased flag is protected from inclimate conditions. The flag receiving closure is preferably comprised of a flexible and slotted dome which, upon drawing the flag against the flexible dome cause the dome to create a flag passageway for drawing the flag into the protective chamber. After the flag passes through the dome, the dome then restructures itself and closes the flag passageway to provide a protective dome for the chamber and the flag internally housed therewithin.

### BRIEF DESCRIPTION OF THE DRAWING

FIG. 1 is a side view of the flag protector integrated into the construction of the flag pole.

FIG. 2 is a side view of a detachable flag protector incorporating the flag protector embodiments shown in FIG. 1 but which may be separately attached as to the flag pole.

FIG. 3 is an enlarged side view depicting the flag being drawn into the flag protector of FIG. 1.

FIG. 4 is an enlarged side view of a top closure for the flag protectors shown in FIG. 1.

FIG. 5 is a side view of a flag protector integrated into the construction of the flag pole and equipped with a deformable dome and a lock for locking the flag within the flag protector.

FIG. 6 is a side view of a flag protector attachment attached to a flag pole equipped with the deformable dome and locking system.

FIG. 7 is an enlarged side view of the tubular flag protecting chamber of the flag protector shown in FIG. 6 detached from the flag pole.

FIG. 8 is a cross-sectional view taken along line 8-8 of FIG. 7 showing in greater detail the locking mechanism for the flag protector.

FIG. 9 is an enlarged perspective elevational top view of the protective dome for the flag protector shown in FIG. 7.

FIG. 10 depicts FIG. 5 with an unflurred flag.

FIG. 11 shows the flag protector attachment of FIG. 6 upon commencement of drawing the flag into the flag protector attachment.

FIG. 12 illustrates the flag shown in FIG. 11 after the flag has been withdrawn within the flag protector.

FIG. 13 is a partial cross-sectional view of the protective chamber with an unflurred flag taken along line 13-13 of FIG. 12.

FIG. 14 is a partial cross-sectional view of the flag protector shown in FIG. 10 taken along line 14-14 of FIG. 10.

### DETAILED DESCRIPTION OF THE INVENTION

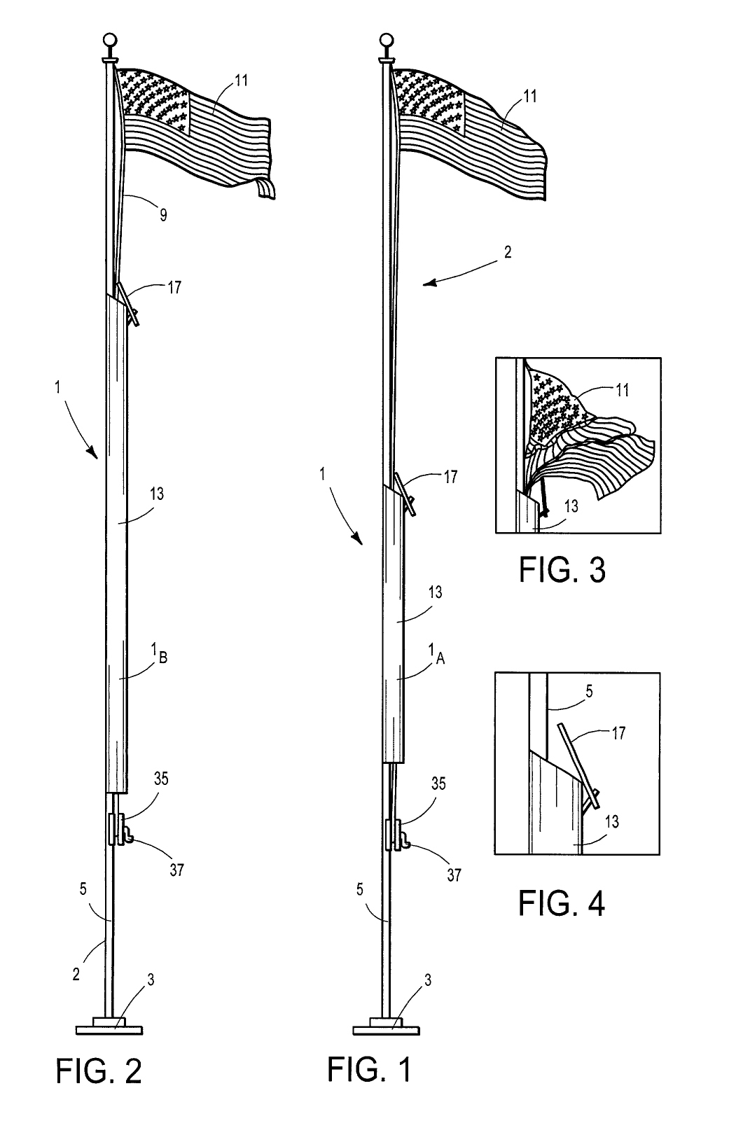

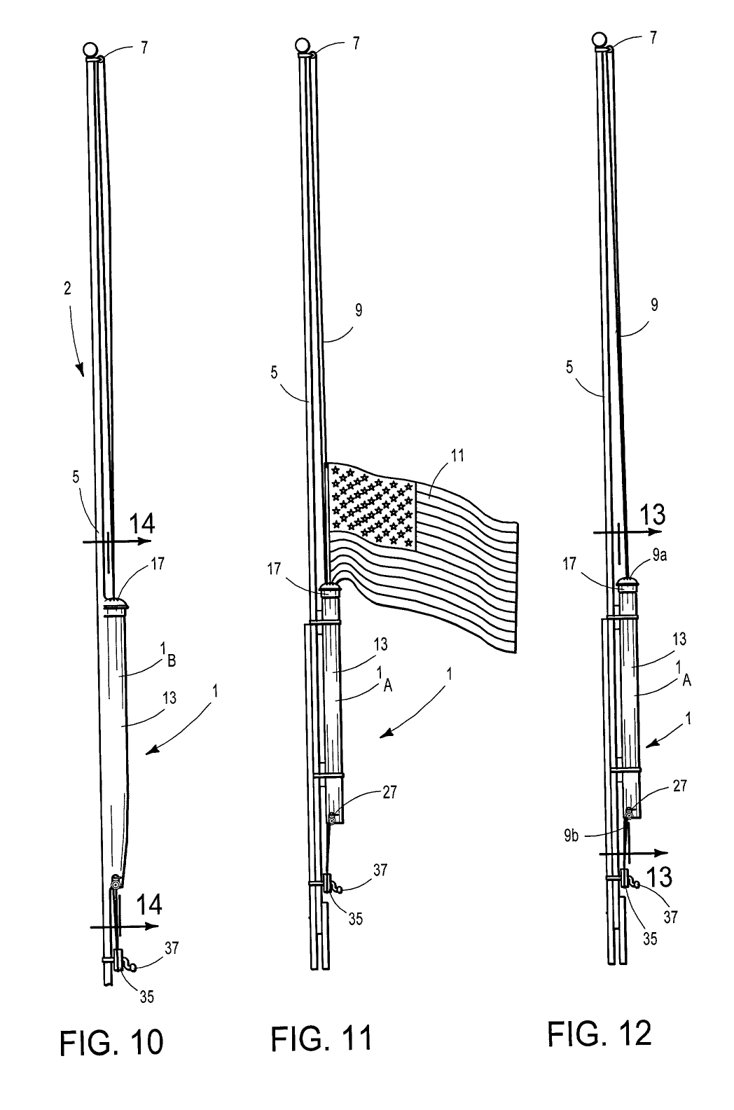

Pursuant to the present invention, there is provided a flag protecting device (generally referenced as 1) which may be used as an attachment (as illustratively depicted as 1A) for attaching to an existing flag pole ensemble (generally referred to as 2) as depicted by FIGS. 1, 6, 1 & 12 or which may be integrated into the construction of the flag pole 2 to provide a flag pole 2 and a flag protector of a unitary construction (as illustratively depicted as 1B) as shown in FIGS. 1, 10 & 14. When flag protector 1 is provided as an auxiliary unit, the unit may be equipped with fasteners 12 (e.g., mounting brackets) such as worm screwed metal clamping bands to secure the tubular member 13 to a flag staff 5 as illustrated by FIGS. 6 and 11-13. The flag protecting device 1 is adapted for use with a conventional flag pole ensemble 2 which often includes a base 3 supportive of the ensemble 2, a flag staff or pole 5 fitted with an upper pulley 7 positioned at a top end of the flag staff 5 and a continuous rope 9 engaging or pullied onto the upper pulley 7 so as to permit a flag 11 to be raised to a full flagging position illustrated by FIGS. 1-2 and 5-6 or lowered to a non-flagging or unfurled position as illustrated by FIGS. 10-14. Rope 9 (commonly referred to as a halyard) is typically secured to an upper flag eyelet 11a and a lower flag eyelet 11b which maintain the staffed flag 11 in an appropriate flagging position as depicted in FIGS. 1-3, 5-6 and 11.

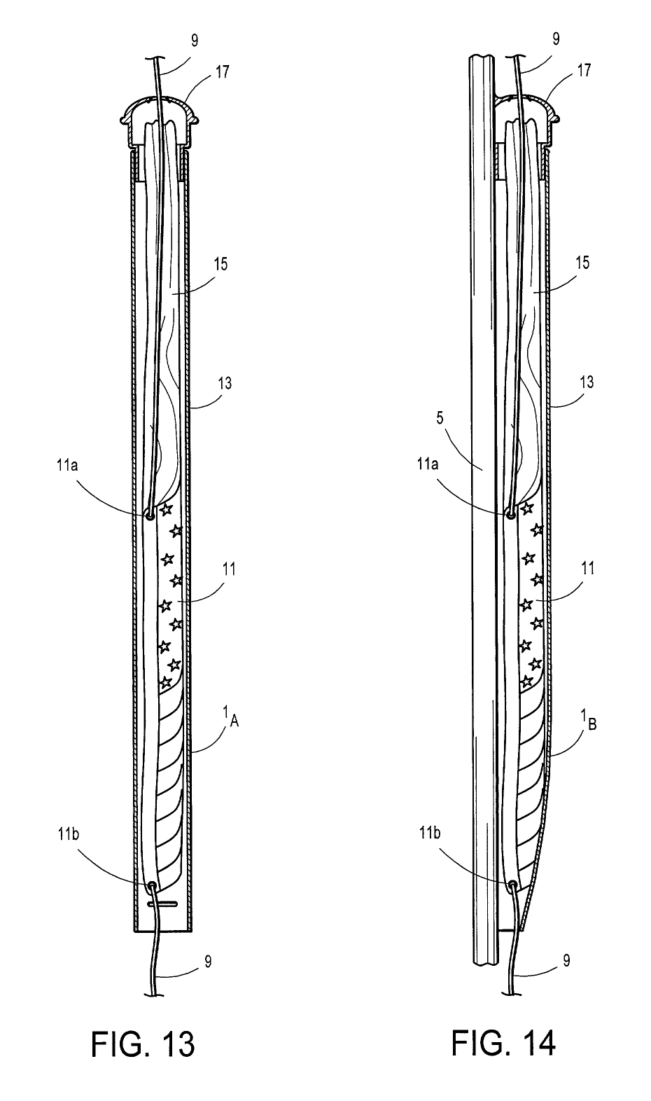

The flag protector 1 comprises a tubular member 13 having an internal chamber 15 for protectively housing flag 11 within the tubular member 13 as best illustrated by FIGS. 10 and 12 and the cross-sectional views thereof of FIGS. 13 & 14. The tubular member 13 extends along the longitudinal axis of the flag staff 5 for a distance sufficient to provide sufficient stowage space for stowing flag 11. Tubular member 13 also has a sufficient internal diameter to house flag 11. The internal chamber 15 should not be too small nor excessively large so as to become unsightly upon the flag ensemble 2. The most commonly used household flags measuring 3 feet by 5 feet and the slightly larger business flags (e.g. 4″×6″) can be easily accommodated in an internal cavity 15 measuring about 4 inch internal diameter tube. For most uses, the internal diameter of internal chamber 5 will range from about 2 to about 6 inches and most typically from about 3 to 5 inches.

The flag protector 1 includes a closure 17 along the top margin of the tubular member 13 which serves to seal the chamber 15 and enclosed flag 11 from the elements. The closure 17 in the preferred embodiments of the invention allows closure 17 to close and seal chamber 15 from the elements when the flag 11 has either been withdrawn from chamber 15 (e.g., see FIGS. 1-2, 4-7 and 9) or housed within the internal chamber 15 as cross-sectionally depicted by FIGS. 12-14. Closing chamber 15 with closure 17 when the flag 11 is not flagging or flagging protects chamber 15 and housed flag from external water, debris, soilage and damage. The closure 17 may be pivotally mounted at the top of the internal chamber 15 (as shown in FIGS. 1-4) so that it may be (manually or automatically) closed by pivoting the closure 17 to the closed position (as shown in FIGS. 1-2 & 4). When the flag 11 is raised from chamber 15 along the flag staff 5, the pivotally mounted closure or flap 17 is forced open by the pressure of the emerging flag 11. The pivotally mounted closure 17 may be weighted so as to normally close unless forced to open. Alternatively, closure 17 may be simply mechanically opened and closed by a rope system, springs or a stick or may be weighted similar to pivotally mounted caps for internal combustion engines such as conventionally used on farm tractors. If desired, flag protector 1 may include an electrical system cooperatively connected to a light sensor so as to open the closure 17 and raise the flag 11 at dawn and to lower the flag 11 and close the cap at dusk. Other known electronic control systems such as electrically powered motors activated in timed intervals or by moisture sensory monitors may be incorporated into the design and construction of flag protector 1. Similarly, remote controls such as currently used for TVs, automatic door openers, etc., can be utilized to raise and lower the flag 11 as well as closing and opening the closure cap 17.

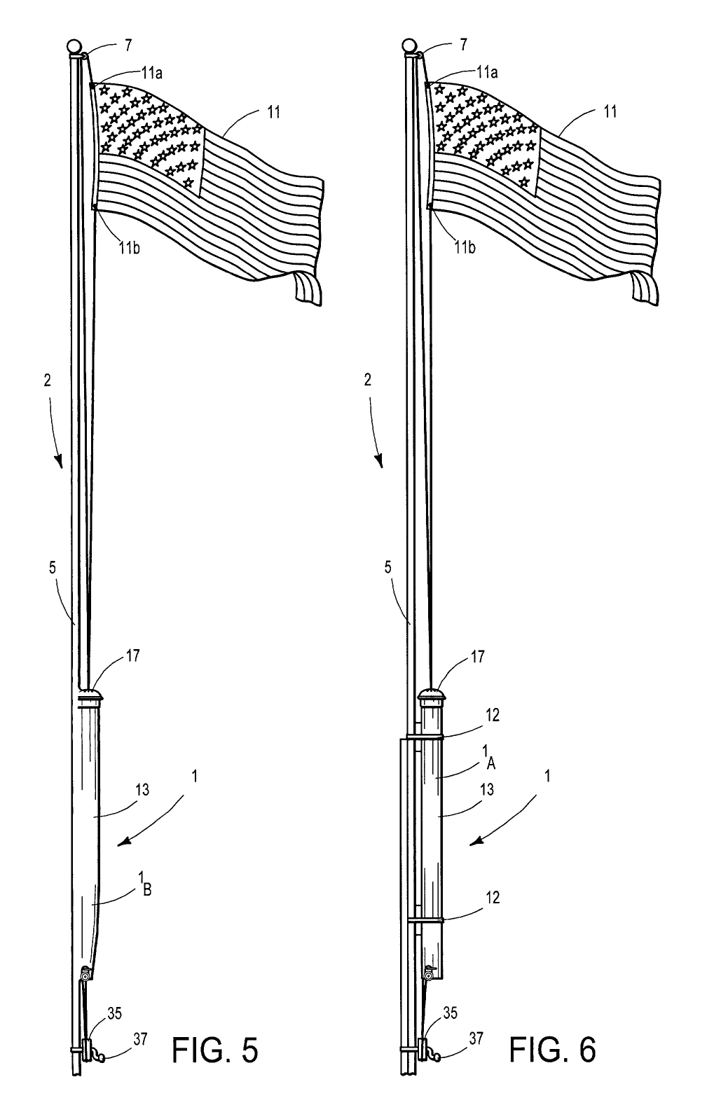

In the preferred embodiments of the invention as depicted by FIGS. 5-7, 9 & 11-14, closure 17 comprises a flexible dome 17 equipped with slotted orifices 19 radically extending which, upon pressure of flag 11 against slotted orifice 19, causes orifice 19 to open into a flag passageway 19a so as to permit passage of flag 11 therethrough. Once the flag 11 has passed through the orifice 19, slotted orifice 19 then flexible closes to form protective dome 17 as shown in FIGS. 5-7, 9 and 11-14. Dome 17 is preferably of a flexible elastic construction which upon pressure flexes and stretches to create flag passageway 19a. Such flexible materials possess what is often referred to as memory characteristics which will elastically deform and then return to their original form upon the cessation of deformable pressures. Typical of such elastic materials are rubbers and plastics and particularly, the synthetic and natural rubber products equipped with a slotted orifice 19 as shown in more detail by FIG. 9.

The closure 17 as depicted by FIGS. 5-7, 9 & 11-14 is designed so that the pressure of the ascending or descending flag 11 pulled by rope 9 creates pressure against closure or dome 17 causes the slotted orifice 19 to open and remain open by pressure of the raising or ascending flag 11. After flag 11 has passed through dome 17 or slotted orifice 19, then dome 17 and slotted orifice 19 elastically close to protect chamber 15 and the encased flag 11 from the elements as illustrated by FIGS. 10, 12 and 13-14. Such a closure 17 may be obtained by cutting a centrally disposed orifice located at the epicenter of rubber dome 17 and slicing a sufficient number of radial extending slots 19s so as to provide a sufficient passageway 19a for passage of flag 11 therethrough. The width of the slot cuts or diameter of orifice 19o is not as controlling as the number of slots and radial slot of the length. Dome 17 will usually contain at least three radially extending slots 19s and advantageously four or more radial extending slots 19s. The radially extending slots 19s extend outwardly for a sufficient distance from orifice 19o so as to afford passage of flag 11 therethrough. Slots 19s radially positioned at equidistant angular positioning ranging from about 45 to 90 degrees and advantageously from about 50 to about 70 degrees provide a suitable slotted passageway 19a. The orifice 19o size is not critical since it merely provides the centeroid for flexing the slotted pie shaped flaps 19f to a flag receiving configuration. As is shown in FIG. 9, eight slots 23 typically measuring approximately 1½ inches in length radiating outwardly from a centeroid measuring about ½ inch in diameter are generally sufficient to provide a passageway 19a for a standard flag 11. The radially extending slots 19s may extend to the outer periphery of dome 17 and preferably are thinly slotted so as to provide a more tightly closed dome 17 when closed. Slots measuring from about 1 to about 3 inches may typically be used for this purpose.

The most appropriate length for the internal chamber 15 will depend upon the maximum flag length. For a standard flag 11 measuring 3 feet by 5 feet, the length of the tubular member 13 will typically measure about 4 to about 6 feet in length and about 3 to about 4 inches in diameter. The tubular member 13 as depicted by FIGS. 1, 6 and 11-12 may be attached to the flag pole 5 with bands with a screw tightener. For larger flags, each additional foot in flag length will add 1 foot 2 inches to the tube 13 length. Typically for a standardized flag, a 3″ diameter tubular member is insufficient to accommodate the flag while a six inch diameter tube is unnecessary. For flags of a 4′×6′ size, a 4″ diameter tube is generally adequate to house the flag.

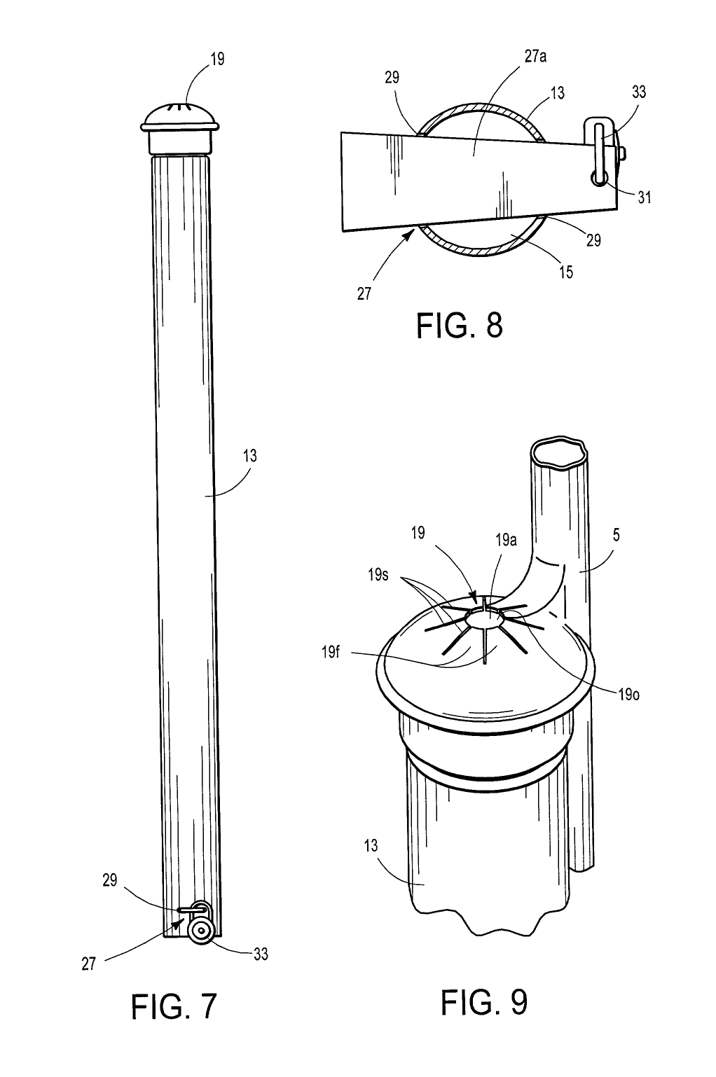

FIGS. 5-8 & 11-13 illustrate a satisfactory locking system (generally referenced as 27) in which the flag 11 may be protectively locked within the tubular member 13 so as to protect the flag 11 from theft. As illustrated in greater detail by FIGS. 7 and 8, the locking system 27 includes a tapered tab 27a which extends cross-wise across the bottom of the tubular member 13.

As may be observed from FIG. 8, the locking member 27 is of tapered construction wider in width at an end opposite of padlock 33. The tapered bar 27a passes through slotted orifices 29 sized so as to mate onto the locking bar 27a and prevent removal of bar 27a when inserted into slotted orifices 29 of tubular member 13 and locked thereto with padlock 13 as shown in FIG. 9. At the opposite end of the bar 27a, there is simply provided a padlock receiving orifice 31 in which the padlock 33 can be locked onto. Once the padlock 33 is locked, padlock 33 prevents slat or bar 27a from being withdrawn from the slotted orifices 29. Accordingly, locking member 27 protects the flag 11 housed within internal chamber 15 from theft.

Although not necessary, flag pole 5 may be equipped with a winch 35 and a handle 37 for cranking winch 35 and winding halyard 9 about winch 35 in the appropriate direction for raising or lowering flag 11 along flag staff 5. Winch 35 may be equipped for manual operations as shown or for motorized operation by connecting a motor (e.g., electric) powered by a suitable power source (e.g., battery or AC power source). If desired light sensor, inclimate weather detectors or sensors, remote controls, etc., may be appropriately connected to winch 35 to provide an automatic flag raising and lowering system.

The depicted flag 11 raising and lowering system includes a rope or halyard 9 equipped with a lower flag mounting eyelet 11b and upper flag mounting eyelet 11a laterally spaced so as to span the flag width and maintain flag 11 in the flagging position. Halyard 9 is in the form of continuous rope or cable 9 drawn about pulley 7 in the appropriate direction for raising or lowering flag 11. Halyard 9 enters the top of tubular member 13 at dome orifice 19 into the confines of internal chamber 15 and exits through the open structure at the bottom of tubular member 13. This allows halyard 9 to be drawn freely about pulley 7 as well as to and from chamber 15.

What is claimed is:

1. A flag protector for housing a flag staffed upon a flag pole equipped with a rope for raising and lowering the flag, said flag protector comprising an elongated tubular member for positioning along a vertical axis of the flag pole with said tubular member including an internal chamber for housing the flag when lowered to an unflurred position within said internal chamber, a rope passageway communicating through said internal chamber so as to permit the flag to be drawn into said internal chamber and from said internal chamber, a protective cap which may be opened so as to permit ingress and egress of the flag from the internal chamber and closure means for closing the protective cap onto the tubular member and thereby protect the internal chamber and the unflurred flag housed therein against penetrations by external elements.

2. The flag protector according to claim 1 wherein a lower portion of the tubular member includes a lock for locking the internal chamber from external access and thereby protecting the flag from unauthorized removal from the internal chamber.

3. The flag protector according to claim 1 wherein the protective cap comprises a flexible dome equipped to provide a deformable passageway for said flag and said rope with said dome being of a flexible construction so that upon pressure of an emerging flag against the dome will deform into a flag passageway so as to allow passage of the flag therethrough and which flexible structure upon cessation of pressure against the dome will flexibly return to an originating dome structure so as to provide protection to the internal chamber from penetration by external elements.

4. The flag protector according to claim 3 wherein the dome consists essentially of a flexible rubber dome.

5. The flag protector according to claim 1 wherein the tubular member is integrated into the construction of the flag pole to provide integral unit of a unitary construction.

6. The flag protector according to claim 1 wherein the tubular member comprises a mountable tubular member for detachably mounting the tubular member to the flag pole.

7. The flag protector according to claim 6 wherein the flag protector includes mounting brackets for mounting the tubular member to the flag pole.

8. The flag protector according to claim 7 wherein a bottom portion of the tubular member includes a lock for securing the internal chamber against unauthorized access.

9. The flag protector according to claim 8 wherein the lock comprises a tapered insert and a pair of laterally disposed tapered insert receiving orifices positioned about the lower portion of the tubular member to receive the tapered insert and thereby prevent removal of the flag when the tapered insert cross-sectional bridges the internal chamber between said tapered receiving insert orifices.

10. The flag protector according to claim 9 wherein the tapered insert comprises a tapered slat tapering outwardly from a narrower width portion to a broader width portion and including a padlock receiving orifice for locking a padlock onto the narrower width portion of said tapered slat.

11. The flag protector according to claim 6 wherein the protective cap comprises a flexible dome equipped with a resilient flag passageway which upon pressure of an emerging flag will deform so as to allow passage of the flag therethrough and upon discontinuance of pressure will resiliently return to a protective dome-shaped configuration.

12. A flag protector for use in connection with a flag pole having a flag, an upper pulley, and a rope engaging onto said flag and said upper pulley so as to permit the flag to be raised to a flagging position and to be lowered to a non-flagging position with said rope, said flag protector comprising a tubular member having an internal chamber for housing the flag within said tubular member with said tubular member defining a longitudinal axis for alignment onto said flag pole, a flag receiving closure bordering along a top margin of the tubular member for allowing ingress and egress of the flag from the internal chamber and closure of the internal chamber after passage of the flag and a rope passageway entering and exiting said internal chamber so as to permit the flag to be withdrawn from the internal chamber to the flagging position and drawn within the internal cavity to the non-flagging position with said rope.

13. The flag protector according to claim 12 wherein the flag receiving closure comprises a flexible dome equipped with a slotted orifice which upon a drawing of the flag against the flexible dome causes the slotted orifice to deform into a flag receiving passageway and after passage of the flag therethrough closes the flag receiving passageway so as to provide a protective dome for said flag housed within said internal chamber.

14. The flag protector according to claim 13 wherein the tubular member includes a lock for locking the internal chamber.

15. The flag protector according to claim 14 wherein the tubular member comprises a cylindrical tubular member open for the passage of the flag therethrough and the flag protector includes mounting brackets for mounting the tubular member to the flag pole.
